(19) United States
(12) Patent Application Publication
(10) Pub. No.: US 2026/0312213 A1
(43) Pub. Date: Oct. 8, 2026

(54) BATTERY HOUSING FOR RECEIVING A PLURALITY OF BATTERY COMPONENTS, BATTERY COMPRISING A BATTERY HOUSING, AND BATTERY SYSTEM COMPRISING A COOLING FLUID STORAGE CONTAINER AND A HEAT EXCHANGER DEVICE

(71) Applicant: KAUTEX TEXTRON GmbH & Co. KG, Bonn (DE)

(72) Inventors: Gero MIMBERG, Köln (DE); Raimund HELMIG, Hoerstel (DE); Stefan LENZ, Bergisch Gladbach (DE)

(73) Assignee: KAUTEX TEXTRON GmbH & Co. KG, Bonn (DE)

(21) Appl. No.: 19/484,607

(22) PCT Filed: May 16, 2024
(86) PCT No.: PCT/EP2024/063613

§ 371 Date: Nov. 14, 2025

(30) Foreign Application Priority Data
May 16, 2023 (DE) 102023112943.0

(51) Int. Cl. H01M 50/291; H01M 10/613; H01M 10/643; H01M 10/6568; H01M 50/213; H01M 50/249

(52) U.S. Cl. CPC H01M 50/291; H01M 10/613; H01M 10/643; H01M 10/6568; H01M 50/213; H01M 50/249; H01M 2220/20

(57) ABSTRACT

A battery housing receives battery components, having a first housing component, a second housing component, and a component holder having cavities receiving the components. Each cavity has an inner wall extending from a first opening of the cavity to a second opening of the cavity, and the at least one component holder is sandwiched between the first and second housing components and connects to each of the housing components such that the first openings face the first housing component and the second openings face the second housing component. The inner walls of the cavities have a groove running from the first opening to the second opening such that, when component is in the cavity, a cooling fluid channel forms from the first opening of the cavity to the second opening of the cavity and which is delimited by the groove and the component.

The present invention relates to a battery housing for receiving a plurality of battery components. Furthermore, the present invention relates to a battery having a battery housing and a battery system having a cooling fluid storage container and a heat exchanger device.

In batteries, especially in high-performance batteries such as those used as traction batteries for motor vehicles, high powers are converted during charging and discharging. Such batteries can presently be operated with voltages of up to several hundred volts. In addition, at present, charging and discharging currents of several hundred amperes can occur. The requirements in terms of the power consumption of such batteries will continue to increase in the future. These high power consumptions presently lead to high, and in the future even higher, thermal losses in the battery during charging and discharging operations. In order to protect the batteries from thermal damage and to achieve high efficiency during charging and discharging, it is important to keep the batteries within a defined temperature range. For this purpose, the battery must be cooled by removing the amount of heat generated by thermal losses.

Various types of cooling are known from the prior art. Basically, the different types of cooling can be differentiated based upon the heat transport medium and the type of heat transfer between the heat transport medium and the battery components.

For example, liquid cooling can be carried out with a heat exchanger through which a liquid heat transport medium flows. The heat exchanger is usually arranged below the battery components, wherein the heat exchanger is thermally conductively connected to the battery components via a contact heat transfer. In this case, the sensitive heat capacity of the liquid heat transport medium is used to absorb heat, emitted by the battery components or the battery, via a temperature difference and to release it either directly into the environment or via an air-conditioning circuit. Electrically conductive liquids or liquid mixtures are usually used as heat transport media. The disadvantage of these cooling systems is that the heat transport medium must under no circumstances come into direct contact with the electrically conductive battery components. This leads to high sealing requirements for the battery housing and thus to high manufacturing costs for the battery housing. Another disadvantage is the increased thermal resistance of the heat transfer between the battery components and the heat transport medium due to the additional heat exchanger required. Finally, the contact heat transfer between the heat exchanger and the battery components, which is usually limited to only one area of the battery components, usually the bottom of the battery components, is disadvantageous. This can lead to an inhomogeneous temperature distribution within the battery components.

As a development of liquid cooling with a heat exchanger in contact with the battery components, the liquid heat transport medium can be evaporated by the heat absorption in the heat exchanger, which leads to higher heat transfers and, due to the evaporation enthalpy, to a high heat absorption per mass of the heat transport medium. After condensation, the heat transport medium can be returned to the heat exchanger in the liquid state. However, the disadvantageously high sealing requirements as well as the still increased thermal resistance of the heat transfer between the battery components and the heat transport medium as well as the locally limited heat transfer remain.

When cooling with air as the heat transport medium, the heat transport medium can be in direct contact with the battery components and, for example, flow around them. This means that an additional heat exchanger is no longer required. However, the disadvantage of this cooling system is the limited heat absorption by air as the heat transport medium. The resulting heat absorption limits are no longer sufficient for the requirements described above for high-performance batteries in motor vehicles, for example.

Finally, two-phase immersion cooling systems are a current development from the prior art. In a manner comparable to the use of air as a heat transport medium, cooling is carried out by a direct flow of a liquid heat transport medium around the components to be cooled. An important property of the liquid heat transport medium is therefore its dielectricity, since the heat transport medium is in direct contact with the battery components, i.e., with electrically conductive and potential-carrying components. In addition to the high heat transfer through the direct flow around the components to be cooled, the evaporation enthalpy of the dielectric, liquid heat transport medium, and the associated high heat absorption capacity can also be used if the heat transport medium evaporates during the heat transfer due to the heat input from the battery cells to be cooled. The disadvantage of such cooling systems is the often high technical complexity and the additional units required to realize active circulation of the heat transport medium in the cooling circuit. This additional effort has a negative impact upon the overall cooling efficiency.

The present invention is based upon the object of providing a battery housing for receiving battery components, which battery housing allows for more efficient cooling of the battery components and, at the same time, has improved torsional and flexural rigidity.

The object of the present invention is achieved by a battery housing with the features of claim 1 of the present invention. Advantageous embodiments of the battery housing are described in the claims dependent upon claim 1.

More specifically, the object of the present invention is achieved by a battery housing for receiving a plurality of battery components, having a first battery housing component, a second battery housing component, and at least one battery component holder, which has a plurality of receiving cavities for receiving the battery components, wherein each of the receiving cavities has an inner wall which extends from a first opening of the respective receiving cavity to a second opening of the respective receiving cavity, and wherein the at least one battery component holder is sandwiched between the first battery housing component and the second battery housing component and is connected to each of them such that the respective first openings each face the first battery housing component, and the respective second openings each face the second battery housing component. The inner walls of the respective receiving cavities each have at least one groove which extends from the first opening to the second opening, so that, when a battery component is inserted into the receiving cavity, a respective cooling fluid channel is formed which extends from the first opening of the receiving cavity to the second opening of the receiving cavity and is delimited by the groove and the battery component.

The battery housing according to the invention has the advantage that the battery housing features more efficient cooling. When the battery housing is installed, e.g., in a motor vehicle, cooling fluid located in the battery housing is present in the liquid phase in a reservoir in the region between the first battery housing component and the battery component holder. In the reservoir, the cooling fluid is in a state near the boiling point, preferably at the boiling point, of the cooling fluid. The cooling fluid channel formed by the groove of the inner wall of a receiving cavity and a battery component located in the receiving cavity has an inlet opening in the region of the first opening of the receiving cavity and an outlet opening in the region of the second opening of the receiving cavity. The cooling fluid present in the battery housing rises through the inlet opening of the cooling fluid channel into the cooling fluid channel against the force of gravity due to the pressure present in the cooling fluid and, in doing so, absorbs heat from the battery component. Due to the absorbed heat, the cooling fluid begins to boil and evaporate. The evaporating cooling fluid continues to rise along the cooling fluid channel and, in doing so, absorbs heat from the battery component and exits from the outlet opening of the cooling fluid channel, preferably still in the wet steam region. Because the cooling fluid is in direct contact with the battery component while it flows through the cooling fluid channel, the thermal resistance between the cooling fluid and the battery component is reduced, such that improved heat transfer from the battery component to the cooling fluid is achieved.

The battery housing according to the invention also has the advantage that the battery housing features an increased cooling performance. Due to the phase change of the cooling fluid while the cooling fluid flows through the cooling fluid channel, and due to the evaporation enthalpy of the cooling fluid, an increased amount of heat can be absorbed relative to the amount of cooling fluid flowing through the cooling fluid channel. Furthermore, the battery housing according to the invention exhibits more uniform cooling, since the phase change of the cooling fluid occurs isothermally, such that a high temperature homogeneity exists within the cooling fluid.

Finally, the battery housing has the advantage that the battery housing has improved torsional and flexural rigidity. Because the battery component holder is sandwiched between the first battery housing component and the second battery housing component and connected to them, shear forces can be better absorbed, resulting in a torsionally and flexurally rigid battery housing. Furthermore, the required wall thickness of the first battery housing component, of the second battery housing component, and of the battery component holder can be reduced to support the resulting internal pressure.

The battery components are preferably designed as battery cells. The battery cells are preferably designed as cylindrical battery cells. Furthermore, it is also possible for the battery components to be designed as battery modules.

The first battery housing component is preferably designed as a battery housing shell. The first battery housing component can also be referred to as a battery housing bottom shell or, in general, as a bottom shell.

The second battery housing component is preferably designed as a battery housing shell or as a battery housing lid, wherein the battery housing lid can also be designed as a battery housing shell. The second battery housing component can also be referred to as a battery housing top shell or, in general, as a top shell.

The battery component holder can also be referred to as a battery cell holder or as a cell holder.

Each receiving cavity is designed to receive one battery component. The receiving cavities are designed as through-openings in the battery component holder. The receiving cavities are preferably cylindrical. A free cross-section of the receiving cavities is preferably circular.

Alternatively, the receiving cavities are rectangular-preferably square. A free cross-section of the receiving cavities is preferably rectangular, and particularly preferably square.

The inner wall or parts of the inner wall of the respective receiving cavities come into contact with a battery component, e.g., with a battery cell, when the battery cell is inserted into the receiving cavity. A battery housing designed in this way has the advantage that the battery components can be received in an improved manner, in particular in an improved and fixed manner, in the battery housing. This reduces unwanted changes in the position of the battery components within the battery housing.

A free cross-section of the respective receiving cavities is preferably smaller than a cross-section of the respective battery components. A battery housing designed in this way has the advantage that the battery components can be received in the battery housing in a further improved and fixed manner. In particular, a non-positive connection is formed between the respective receiving cavity and the battery component inserted into the receiving cavity.

The respective grooves of the inner walls preferably extend parallel to a longitudinal extension of the respective receiving cavities. The longitudinal extension of a receiving cavity runs from the first opening to the second opening of the receiving cavity.

The respective grooves are each formed continuously from the respective first openings of the respective receiving cavities to the respective second openings of the respective receiving cavities.

The respective cooling fluid channels formed are designed to conduct a cooling fluid.

The respective cooling fluid channels formed have an inlet opening in the region of the first opening of the receiving cavity and an outlet opening in the region of the second opening of the receiving cavity, wherein a free cross-section of the inlet opening is preferably smaller than a free cross-section of the outlet opening. A battery housing designed in this way has the advantage that the battery housing features more efficient cooling.

The inner walls of the respective receiving cavities preferably have more than one groove. A battery housing designed in this way has the advantage that the battery housing exhibits further improved cooling performance.

The inner walls of the respective receiving cavities preferably have at least two, four, eight, twelve, fourteen, sixteen, or more grooves extending in the longitudinal extension of the receiving cavity. More preferably, the grooves are arranged equiangularly to one another around a longitudinal axis of the receiving cavity. The longitudinal axis of the receiving cavity preferably runs through the centers of the free cross-sections along the longitudinal extension of the receiving cavity. A battery housing designed in this way has the advantage that the battery housing features further improved cooling performance and, at the same time, allows for more uniform cooling of battery components due to an enlarged cooled surface of the battery components.

Preferably, the inner walls of the respective receiving cavities have grooves arranged at least partially in groups. Two or more grooves arranged in a group in a receiving cavity are closer to one another than to the other grooves of the same receiving cavity. For example, two grooves can be arranged in a group of two. The grooves arranged in a group of two are closer to one another than to other grooves of the same receiving cavity. Preferably, the receiving cavities each have six grooves arranged in groups of two. Alternatively, the receiving cavities each have four grooves arranged in groups of three. A battery housing designed in this way has the advantage that the battery housing has an increased packing density and also further improved torsional and flexural rigidity. Grooves arranged in groups can be arranged in the inner walls of the receiving cavities such that the battery component holder has at every point an optimal material distribution in terms of torsional and flexural rigidity.

The battery component holder is preferably integrally connected to the first battery housing component and/or to the second battery housing component, in particular by welding and/or gluing. A battery housing designed in this way has the advantage that the battery housing has improved torsional and flexural rigidity.

More preferably, the battery component holder is connected positively and/or non-positively to the first battery housing component and/or to the second battery housing component. The positive and/or non-positive connection can be designed as a rear engagement and/or as a clamping connection. A battery housing designed in this way has the advantage that the battery housing has further improved torsional and flexural rigidity.

Preferably, the battery housing is designed such that the at least one groove along its longitudinal extension has a varying groove depth.

A battery housing designed in this way has the advantage that the battery housing features even more efficient cooling. During charging and discharging operations, battery components received in the battery housing generate different amounts of heat along the longitudinal extension of the battery components. Due to the varying groove depth along its longitudinal extension, a cooling fluid flowing through the cooling fluid channel can absorb different amounts of heat along the longitudinal extension of the battery component, such that need-based and thus more efficient cooling is achieved.

The groove depth is the direction of extension of the groove that extends orthogonally to the longitudinal extension of the groove and, starting from a center of a free cross-section of the receiving cavity, extends radially in the direction of the inner wall of the receiving cavity. In other words, the groove depth of the groove increases the free cross-section of the receiving cavity in the radial direction.

Preferably, the at least one groove has a constant groove width along its longitudinal extension. The groove width extends orthogonally to the longitudinal extension of the groove and orthogonally to the groove depth of the groove.

Preferably, the battery housing is designed such that the groove depth of the at least one groove varies stepwise along its longitudinal extension.

A battery housing designed in this way has the advantage that the battery housing features even more efficient cooling. The local pressure within the cooling fluid channel, which is formed by a groove designed in this way and by a battery component inserted into the receiving cavity, also varies stepwise due to the stepwise-varying groove depth. Along the longitudinal extension of the cooling fluid channel, the local pressure within the cooling fluid channel can thus, stepwise, be above or below the vapor pressure of the cooling fluid. This allows the amount of heat absorbed by a cooling fluid along the longitudinal extension of the battery component to be adjusted in a further improved, need-based manner by evaporation of the cooling fluid. This in particular makes it possible to vary, in particular increase, the heat transfer rate from the battery component to the cooling fluid.

Preferably, the battery housing is designed such that the at least one groove in the region of the first opening of the receiving cavity has a first groove depth which is smaller than a second groove depth in the region of the second opening of the receiving cavity.

A battery housing designed in this way has the advantage that the battery housing features even more efficient cooling and, at the same time, further increased cooling performance. The cooling fluid rises into the cooling fluid channel in the region of the first opening of the receiving cavity. Due to a second groove depth that is greater than the first groove depth, cooling fluid flowing through the cooling fluid channel is evaporated more easily in the transition from the first groove depth to the second groove depth, absorbing heat energy from the battery component. The cooling fluid is expanded by the larger second groove depth, such that the local pressure in the region of the second groove depth is below the existing vapor pressure.

Preferably, the battery housing is designed such that the first groove depth is between 0.1 mm and 1 mm, more preferably between 0.2 mm and 0.4 mm, and even more preferably 0.3 mm, and that the second groove depth is between 0.5 mm and 2 mm and more preferably 0.8 mm.

A battery housing designed in this way has the advantage that the battery housing exhibits even more efficient cooling. Tests have shown that the cooling fluid rises in a particularly improved manner into the formed cooling fluid channel in the case of a first groove depth between 0.1 mm and 1 mm, preferably 0.3 mm. Furthermore, tests have shown that cooling fluid evaporates particularly easily in the case of a second groove depth in the range of 0.6 mm and 1 mm, preferably 0.8 mm. Surprisingly, it has been shown that the combination of the regions of the first groove depth and of the second groove depth leads to even more efficient cooling. In particular, in the region of the first groove depth, exactly as much cooling fluid can rise into the cooling fluid channel as evaporates in the region of the second groove depth, and continues to rise up the cooling fluid channel. This ensures a constant evaporation process.

Preferably, the battery housing is designed such that the at least one groove has the first groove depth over a longitudinal extension of 1 mm to 8 mm, more preferably of 1 mm to 5 mm, and even more preferably 2 mm.

A battery housing designed in this way has the advantage that the battery housing features even more efficient cooling and, at the same time, further increased cooling performance. Surprisingly, it has been shown that, by the longitudinal extension of the first groove depth in the range of 1 mm to 8 mm, preferably 2 mm, the amount of cooling fluid flowing through the cooling fluid channel is adjusted such that the cooling fluid has a vapor content in the range of 50% when exiting from the outlet opening of the cooling fluid channel, so that the cooling fluid absorbs an even greater amount of heat relative to the cooling fluid flowing through the cooling fluid channel.

Preferably, the battery housing is designed such that the inner walls of the respective receiving cavities each have at least one crush rib extending from the first opening in the direction of the second opening, so that, when a battery component is inserted into the receiving cavity, the crush rib is deformed, and the battery component is held without play in the receiving cavity.

A battery housing designed in this way has the advantage that the battery housing features even more efficient cooling. By holding the battery component in the receiving cavity without play, the cooling fluid channel formed by the battery component and the groove is better sealed against the receiving cavity, so that less cooling fluid enters the receiving cavity. Furthermore, a battery housing designed in this way has the advantage that battery components inserted into the receiving cavities are held better in the receiving cavities. This gives the battery housing improved torsional and flexural rigidity.

The feature that the crush rib extends from the first opening of the receiving cavity in the direction of the second opening of the receiving cavity can also be expressed as the crush rib having a longitudinal extension from the first opening of the receiving cavity in the direction of the second opening of the receiving cavity.

Preferably, the inner walls of the respective receiving cavities each have three crush ribs or four crush ribs or more crush ribs. The crush ribs of each receiving cavity are preferably equidistant from one another. In particular, the crush ribs of each receiving cavity are arranged equiangularly to one another around the longitudinal axis of the receiving cavity.

A battery housing designed in this way has the advantage that the battery housing features even more efficient cooling and, at the same time, improved torsional and flexural rigidity. The three or more crush ribs even more firmly hold battery components held in the receiving cavities. In addition, the battery components being received without play in the receiving cavities makes the battery component holder itself more rigid. Finally, receiving without play reduces component vibrations, in particular in the event that a battery component received in the battery component holder loses contact with a protrusion.

Preferably, the battery housing is designed such that the at least one crush rib extends from the first opening of the receiving cavity over a length of 5 mm to 15 mm, preferably 7 mm, in the direction of the second opening of the receiving cavity.

A battery housing designed in this way has the advantage that the battery housing exhibits even more efficient cooling. Tests have shown that a crush rib extending from the first opening over a length of 5 mm to 15 mm, preferably 7 mm, in the direction of the second opening further improves the sealing of the cooling fluid channel against the receiving cavity, such that even less cooling fluid enters the receiving cavity.

Preferably, the battery housing is designed such that the at least one crush rib has a height extension of 0.1 mm to 0.5 mm, preferably 0.3 mm.

A battery housing designed in this way has the advantage that the battery housing exhibits even more efficient cooling and, at the same time, increased cooling performance. Tests have shown that a crush rib with a height extension of 0.1 mm to 0.5 mm, preferably 0.3 mm, further improves the sealing of the cooling fluid channel. In particular, the cooling fluid channel is better sealed even in the case of increased local pressure in the cooling fluid channel. This allows an increased amount of cooling fluid to flow through the cooling fluid channel, such that an increased amount of heat is transferred from the battery component to the cooling fluid.

The height extension of a crush rib is the direction of extension of the crush rib that extends orthogonally to the longitudinal extension of the crush rib and, starting from the inner wall of the receiving cavity, extends in the direction of the free cross-section of the receiving cavity. In other words, the height extension of the crush rib reduces the free cross-section of the receiving cavity.

Preferably, the battery housing is designed such that the inner walls of the respective receiving cavities each have at least one stabilizer rib extending from the second opening in the direction of the first opening. Preferably, the stabilizer rib has a decreasing height extension along its longitudinal extension starting at the second opening in the direction of the first opening.

A battery housing designed in this way has the advantage that the battery housing has a further improved torsional and flexural rigidity, in particular in the region of the second openings of the receiving cavities of the battery component holder.

Preferably, the at least one stabilizer rib transitions into the inner wall of the receiving cavity. In particular, the at least one stabilizer rib extends from the second opening in the direction of the first opening to half the longitudinal extension of the receiving cavity.

Preferably, the battery housing is designed such that the first battery housing component has a structured inner support surface with a plurality of protrusions, wherein the plurality of protrusions are arranged opposite the plurality of first openings of the respective receiving cavities of the at least one battery component holder so that, when battery components are inserted into the receiving cavities, the battery components rest upon the respective protrusions.

A battery housing designed in this way has the advantage that the battery housing features even more efficient cooling. Because battery components inserted into the receiving cavities rest upon the protrusions, bubble formation of the cooling fluid is avoided when the cooling fluid enters through the inlet opening of the cooling fluid channel, so that the heat transfer coefficient between the cooling fluid and the battery component is improved.

The structured inner support surface is designed to receive a liquid cooling fluid between the protrusions of the inner support surface, such that the liquid cooling fluid forms a continuous reservoir. The protrusions are preferably designed such that the protrusions protrude from the reservoir of the liquid cooling fluid so that battery components resting upon the protrusions do not come into direct contact with the cooling fluid in the reservoir.

Preferably, the protrusions protrude from a base surface of the first battery housing component into a receiving volume of the battery housing, wherein the protrusions have a longitudinal extension in a range of 1 mm to 8 mm, preferably 4 mm. A battery housing designed in this way has the advantage that the battery housing always has a sufficient amount of liquid cooling fluid in the receiving volume of the battery housing, such that a continuous evaporation process of the cooling fluid is achieved. This results in even more efficient cooling of the battery housing.

When the battery housing is installed, e.g., in a motor vehicle, the base surface of the first battery housing component runs in the horizontal plane.

The longitudinal extension of the protrusions runs orthogonally from the base surface of the first battery housing component into the receiving volume of the battery housing.

Preferably, the protrusions are cylindrical. Alternatively, the protrusions have a cross-sectional area corresponding to the cross-sectional area of the battery components.

Preferably, the protrusions each have a smaller diameter than the receiving cavities. A battery housing designed in this way has the advantage that cooling fluid, which is received in the structured inner support surface and forms a reservoir, can better enter the cooling fluid channel through the inlet opening of the cooling fluid channel.

Preferably, the first battery housing component has a plurality of connecting protrusions extending from the base surface of the first battery housing component into the receiving volume of the battery housing. The connecting protrusions are preferably cylindrical. The connecting protrusions are each preferably arranged adjacent to three protrusions. The connecting protrusions preferably have a smaller cross-section than the protrusions. The connecting protrusions of the first battery housing components are designed to form a connection, preferably an integral connection, with the battery component holder.

A battery housing designed in this way has the advantage that the battery housing has improved torsional and flexural rigidity.

Preferably, the battery housing is designed such that the first battery housing component has a circumferential inner wall contour that corresponds to an outer wall contour of the at least one battery component holder, wherein the at least one battery component holder is connected to the first battery housing component such that the outer wall contour of the at least one battery component holder conforms to the inner wall contour of the first battery housing component.

A battery housing designed in this way has the advantage that the battery housing has further improved torsional and flexural rigidity. Because the inner wall contour of the first battery housing component conforms to the outer wall contour of the battery component holder, an additional positive connection is created between the battery component holder and the first battery housing component.

Preferably, the second battery housing component has a circumferential inner wall contour that corresponds to the outer wall contour of the at least one battery component holder. Preferably, the at least one battery component holder is connected to the second battery housing component such that the outer wall contour of the at least one battery component holder conforms to the inner wall contour of the second battery housing component.

A battery housing designed in this way has the advantage that the battery housing has further improved torsional and flexural rigidity. Because the inner wall contour of the second battery housing component also conforms to the outer wall contour of the battery component holder, a further improved, additional positive connection is created between the battery component holder and the second battery housing component.

Preferably, the battery housing is designed such that the battery component holder is integrally connected to the first battery housing component and/or to the second battery housing component by means of welding and/or gluing.

A battery housing designed in this way has the advantage that the battery housing has improved torsional and flexural rigidity.

Preferably, the battery housing is designed such that the battery component holder is additionally connected positively and/or non-positively to the first battery housing component and/or to the second battery housing component.

A battery housing designed in this way has the advantage that the battery housing has further improved torsional and flexural rigidity.

Preferably, the battery component holder is additionally connected positively and/or non-positively to the first battery housing component and/or to the second battery housing component by means of a rear engagement and/or a clamping connection and/or a screw connection.

A rear engagement and/or clamping connection each have at least two, mutually corresponding connecting means. Two, mutually corresponding connecting means are designed to be connected to one another and to maintain this connection non-positively and/or positively.

A clamping connection can be designed as a peg-and-groove connection. A peg-and-groove connection has at least one peg, preferably a cylindrical peg, and a receiving groove corresponding to the peg. A cross-section of the peg can be larger than a free cross-section of the corresponding receiving groove, so that a crimp connection is formed between the peg and the receiving groove when the peg is received in the receiving groove.

The peg can taper conically in its upper region. As a result, the peg can be received more easily in the corresponding receiving groove.

The cylindrical peg can have a circumferential peg groove around the circumference of the peg, and the receiving groove can have an undercut. The receiving groove is preferably configured to engage behind the peg, received in the receiving groove, in the region of the peg groove. The cross-section of the peg can be smaller than the free cross-section of the corresponding receiving groove. A peg-and-groove connection designed in this way can also be referred to as a rear engagement.

Preferably, one of the mutually corresponding connecting means of a rear engagement and/or of a clamping connection is formed monolithically with the battery component holder. The associated, corresponding connecting means is preferably formed monolithically with the first battery housing component and/or with the second battery housing component.

Two monolithically connected components are made from the same component and, in particular, are connected to one another without joints.

A battery housing designed in this way has the advantage that the battery housing features more efficient recyclability and, at the same time, further improved torsional and flexural rigidity. Because the connecting means are an integral part of the battery component holder and/or of the first battery housing component and/or of the second battery housing component, the battery housing features an even smaller number of different materials and thus more efficient recyclability. For example, after removing the battery components and the further electrical components, the battery housing can be mechanically comminuted as a whole and further processed into plastic recyclate, for example.

Preferably, the battery component holder is additionally connected positively and/or non-positively to the first battery housing component and/or to the second battery housing component by means of a screw connection. Preferably, the screw connection has spring washers arranged in the first battery housing component and/or in the second battery housing component. Preferably, the spring washers are at least partially enclosed by material of the first battery housing component and/or by material of the second battery housing component.

Preferably, the first battery housing component and/or the second battery housing component have at least one threaded insert, which is partially enclosed by material of the first battery housing component and/or of the second battery housing component. In particular, the at least one threaded insert is designed as an insert. An insert is formed integrally with the first battery housing component and/or with the second battery housing component during the production of the first battery housing component and/or of the second battery housing component, in particular enclosed by material of the first battery housing component and/or of the second battery housing component in an injection-molding process or an extrusion process.

A battery housing designed in this way has the advantage that the battery housing can be produced more cost-effectively. In particular, the first battery housing component and/or the second battery housing component can be produced in one manufacturing step.

Preferably, the battery component holder and/or the first battery housing component and/or the second battery housing component is/are formed as an injection-molded component.

A battery housing designed in this way has the advantage that the battery housing can be produced more cost-effectively and, at the same time, can be equipped with additional functions in the injection-molding process.

Preferably, the battery component holder and/or the first battery housing component and/or the second battery housing component feature the same material or are formed from the same material.

A battery housing designed in this way has the advantage that the battery housing features even more efficient recyclability.

Preferably, the battery housing is designed such that the battery housing has at least one cooling fluid inlet for supplying a cooling fluid to a receiving volume of the battery housing, and the battery housing has at least one cooling fluid outlet for discharging the cooling fluid from the receiving volume of the battery housing. The at least one cooling fluid inlet is in fluidic connection with the respective first openings of the at least one battery component holder, and the at least one cooling fluid outlet is in fluidic connection with the respective second openings of the at least one battery component holder.

A battery housing designed in this way has the advantage that the battery housing features more efficient cooling. Evaporated cooling fluid can be conducted from the second opening through the cooling fluid outlet from the receiving volume of the battery housing and release the absorbed heat outside the battery housing with liquefaction-for example, in a heat exchanger device. The liquid cooling fluid can be conducted back into the receiving volume of the battery housing through the cooling fluid inlet and can be conducted again through the first opening of the battery component holder to cool battery components inserted into the battery component holder. This creates a closed cooling circuit and thus achieves more efficient cooling.

The cooling fluid inlet and/or the cooling fluid outlet is/are preferably designed as a hollow cylinder, in particular as a connecting piece. More preferably, the cooling fluid outlet and/or the cooling fluid inlet is/are designed as an insert and connected positively and/or non-positively to the first battery housing component and/or to the second battery housing component. Preferably, the cooling fluid inlet and/or the cooling fluid outlet is/are at least partially enclosed by material of the first battery housing component and/or of the second battery housing component.

A battery housing designed in this way has the advantage that the battery housing can be produced in a simplified manner.

When the battery housing is installed, e.g., in a motor vehicle, a longitudinal extension of the cooling fluid inlet is formed in the horizontal direction, and/or a longitudinal extension of the cooling fluid outlet is formed in the vertical direction.

When the battery housing is installed, e.g., in a motor vehicle, the first battery housing component is preferably arranged below the second battery housing component. In other words, the first battery housing component is preferably arranged closer to a surface, e.g., a road, than the second battery housing component when the battery housing is installed in a motor vehicle.

When the battery housing is installed, e.g., in a motor vehicle, a cooling fluid outlet opening of the cooling fluid outlet is preferably arranged opposite a surface-for example, a road.

When the battery housing is installed, e.g., in a motor vehicle, the cooling fluid inlet is preferably arranged below the cooling fluid outlet. For example, when the battery housing is installed, the cooling fluid inlet is arranged in a lower region of the battery housing, in particular in a lower third of the battery housing, and the cooling fluid outlet is preferably arranged in an upper region of the battery housing, preferably in an upper third of the battery housing.

A battery housing designed in this way has the advantage that the battery housing features even more efficient cooling. Because the cooling fluid inlet is arranged below the cooling fluid outlet, the entire cooling circuit can be designed without a cooling fluid feed pump.

Preferably, the battery housing has at least one through-opening, wherein the through-opening is designed to receive a power line and/or a data line and/or a fluid line. The power line and/or the data line and/or the fluid line can extend from the receiving volume of the battery housing through the through-opening out of the receiving volume of the battery housing.

Preferably, the at least one through-opening is arranged on the first battery housing component. Preferably, the through-opening is an integral part of the battery housing and/or of the first battery housing component.

A battery housing designed in this way has the advantage that the battery housing can be produced in a simplified manner, in particular in one manufacturing step.

Preferably, the battery housing is designed such that the at least one cooling fluid inlet and/or the at least one cooling fluid outlet is/are formed in the first battery housing component.

A battery housing designed in this way has the advantage that the battery housing can be produced even more cost-effectively. In particular, the first battery housing component can be produced in one manufacturing step.

When the battery housing is installed, e.g., in a motor vehicle, the cooling fluid inlet is arranged in a lower region of the first battery housing component, in particular in a lower third of the first battery housing component, and the cooling fluid outlet is preferably arranged in an upper region of the first battery housing component, preferably in an upper third of the first battery housing component.

The present invention is also based upon the object of providing a battery which features more efficient cooling and, at the same time, improved torsional and flexural rigidity.

This object of the present invention is achieved by a battery having a battery housing as described above.

More specifically, the object of the present invention is achieved by a battery having a battery housing as described above and having a plurality of battery components designed as battery cells and/or as battery modules and inserted into the receiving cavities of the at least one battery component holder.

The battery according to the invention has the advantage that the battery features more efficient cooling and, at the same time, improved torsional and flexural rigidity.

The present invention is also based upon the object of providing a battery system which features more efficient cooling and, at the same time, improved torsional and flexural rigidity.

This object of the present invention is achieved by a battery system, having a battery with a battery housing and with a plurality of battery components designed as battery cells and/or as battery modules and inserted into the receiving cavities of the at least one battery component holder. The battery housing has a first battery housing component, a second battery housing component, and at least one battery component holder, which has a plurality of receiving cavities for receiving the battery components, wherein the receiving cavities each have an inner wall which extends from a first opening of the respective receiving cavity to a second opening of the respective receiving cavity, and wherein the at least one battery component holder is sandwiched between the first battery housing component and the second battery housing component and is connected to each of them such that the respective first openings each face the first battery housing component, and the respective second openings each face the second battery housing component. The inner walls of the respective receiving cavities each have at least one groove which extends from the first opening to the second opening, so that, when a battery component is inserted into the receiving cavity, a respective cooling fluid channel is formed which extends from the first opening of the receiving cavity to the second opening of the receiving cavity and is delimited by the groove and the battery component. The battery housing has at least one cooling fluid inlet for supplying a cooling fluid to a receiving volume of the battery housing and at least one cooling fluid outlet for discharging the cooling fluid from the receiving volume of the battery housing. The at least one cooling fluid inlet is in fluidic connection with the respective first openings of the at least one battery component holder, and the at least one cooling fluid outlet is in fluidic connection with the respective second openings of the at least one battery component holder. The battery system has a cooling fluid storage container which is fluidically connected to the at least one cooling fluid inlet via a fluid inlet line for supplying cooling fluid to the receiving volume of the battery housing, and a heat exchanger device which is fluidically connected to the at least one cooling fluid outlet by means of a fluid outlet line for discharging the cooling fluid from the receiving volume of the battery housing, wherein the heat exchanger device is fluidically connected to the cooling fluid storage container for supplying liquid cooling fluid.

The battery system according to the invention has the advantage that the battery system features more efficient cooling. When the battery system is installed, e.g., in a motor vehicle, liquid cooling fluid flows from the cooling fluid storage container through the fluid inlet line and the cooling fluid inlet into the receiving volume of the battery housing. The liquid cooling fluid is located in a reservoir in the region between the first battery housing component and the battery component holder. In the reservoir, the cooling fluid is in a state near the boiling point, preferably at the boiling point, of the cooling fluid. The cooling fluid channel formed by the groove of the inner wall of a receiving cavity and a battery component located in the receiving cavity has an inlet opening in the region of the first opening of the receiving cavity and an outlet opening in the region of the second opening of the receiving cavity. The cooling fluid present in the battery housing rises through the inlet opening of the cooling fluid channel into the cooling fluid channel against the force of gravity due to the pressure present in the cooling fluid and, in doing so, absorbs heat from the battery component. Due to the absorbed heat, the cooling fluid begins to boil and evaporate. The evaporating cooling fluid continues to rise along the cooling fluid channel, continuously absorbing heat from the battery component, and exits from the outlet opening of the cooling fluid channel preferably with a vapor content in the range of 50%. The wet steam exits the receiving volume of the battery housing through the cooling fluid outlet and enters the heat exchanger device through the fluid outlet line. In the heat exchanger device, the evaporated cooling fluid releases the heat absorbed from the battery components arranged in the battery component holder and is liquefied again. The liquefied cooling fluid returns from the heat exchanger device to the cooling fluid storage container. This resulting cycle allows for more efficient cooling of battery components inserted into the battery component holder. In particular, a cooling fluid feed pump can be dispensed with.

Preferably, the heat exchanger device is fluidically connected to the cooling fluid storage container via a storage fluid inlet line.

Preferably, the battery system has at least one cooling fluid feed pump, preferably exactly one cooling fluid feed pump, for feeding cooling fluid. The cooling fluid feed pump is preferably arranged between the cooling fluid storage container and the battery housing, preferably in the fluid inlet line. Preferably, the at least one cooling fluid feed pump is arranged between the heat exchanger device and the cooling fluid storage container, preferably in the storage fluid inlet line.

A battery system designed in this way has the advantage that the battery system features increased cooling performance and, at the same time, more robust cooling. The cooling fluid feed pump allows a larger amount of cooling fluid to be fed through the battery housing, so that a larger amount of heat can be removed from the battery housing.

The heat exchanger device is preferably designed such that a cooling fluid flowing through the heat exchanger device releases heat to the environment.

Alternatively or additionally, the battery system has an air-conditioning circuit, wherein the air-conditioning circuit is configured to absorb heat from a cooling fluid flowing through the heat exchanger device.

A battery system designed in this way has the advantage that the battery system features further increased cooling performance. Through the air-conditioning circuit, a cooling fluid flowing through the heat exchanger device can release heat to the air-conditioning circuit in the heat exchanger device regardless of the ambient conditions. As a result, a battery system designed in this way has an extended operating temperature range.

Further advantages, details, and features of the invention can be found below in the described exemplary embodiments. In the figures, in detail:

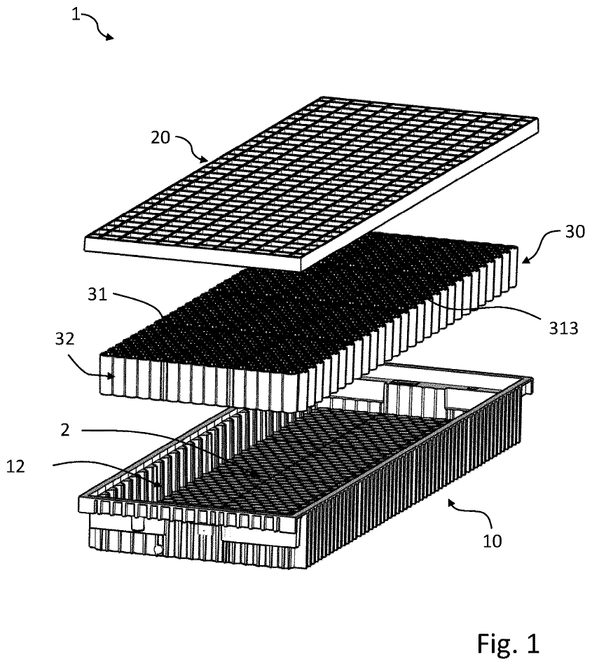

FIG. 1 is an exploded view of a battery housing according to a first embodiment;

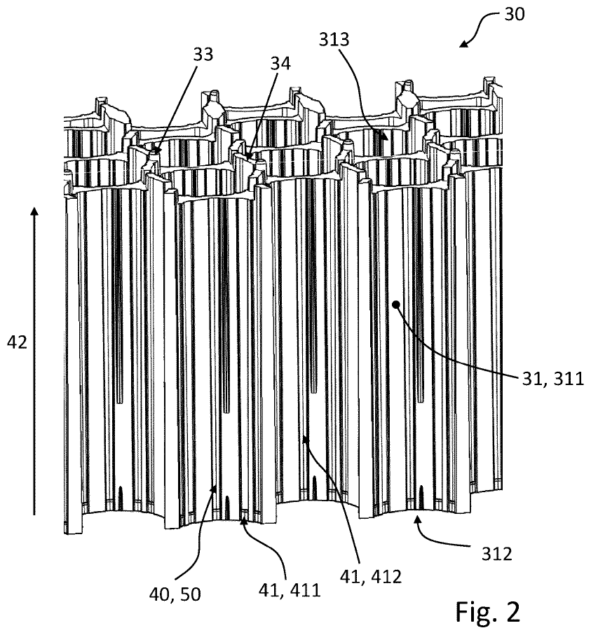

FIG. 2 is a sectional view of a battery component holder in the region of a receiving cavity of a battery housing according to a second embodiment;

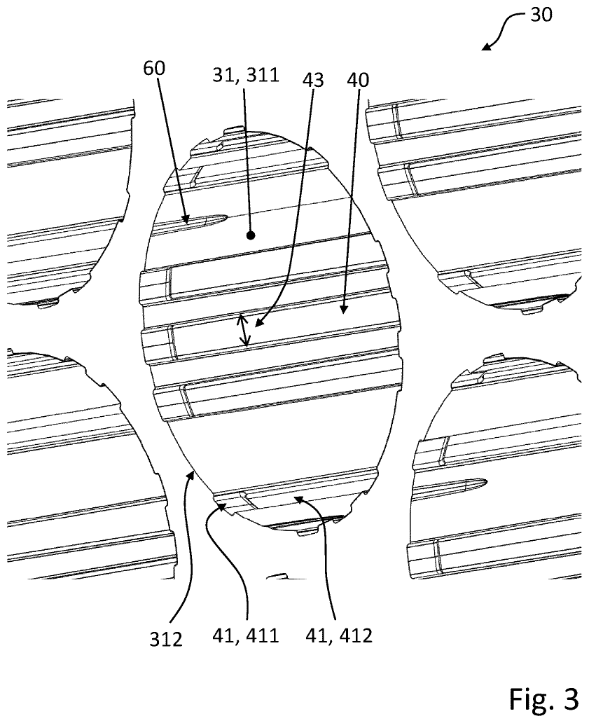

FIG. 3 is a perspectival view of a battery component holder of a battery housing in the region of a receiving cavity according to a third embodiment;

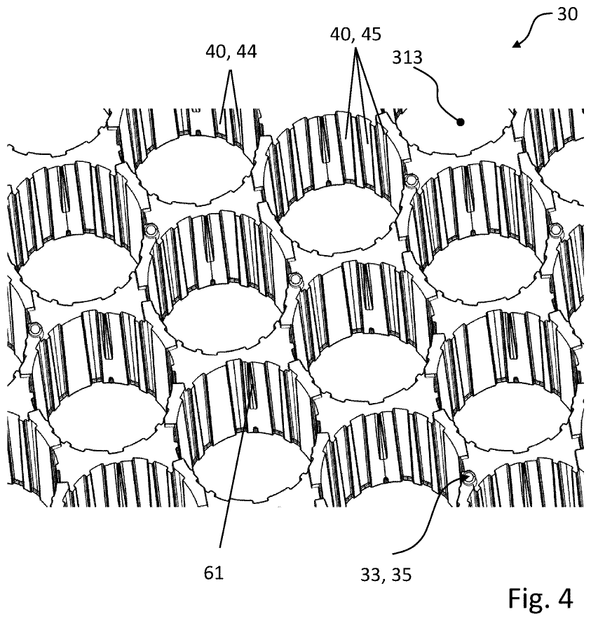

FIG. 4 shows a battery component holder of a battery housing according to a fourth embodiment in a plan view of the second openings of the receiving cavities;

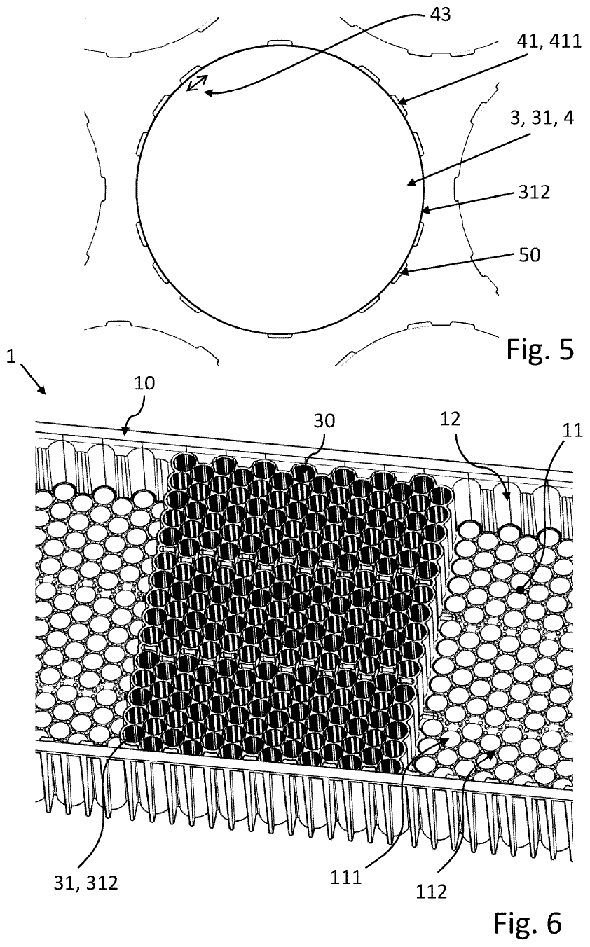

FIG. 5 shows a battery component holder of a battery housing according to a fifth embodiment in the region of a receiving cavity in a plan view of the first opening of the receiving cavity;

FIG. 6 is a perspectival view of a battery component holder, inserted into a first battery housing component, of a battery housing according to a sixth embodiment;

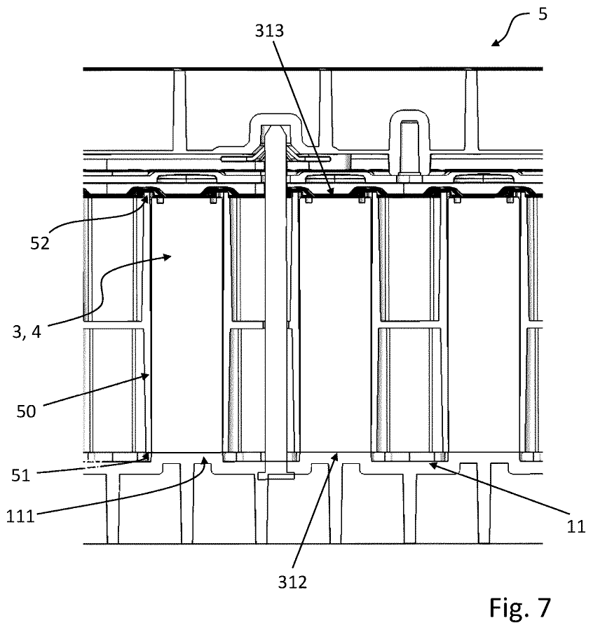

FIG. 7 is a sectional view of a battery in the region of receiving cavities according to a seventh embodiment;

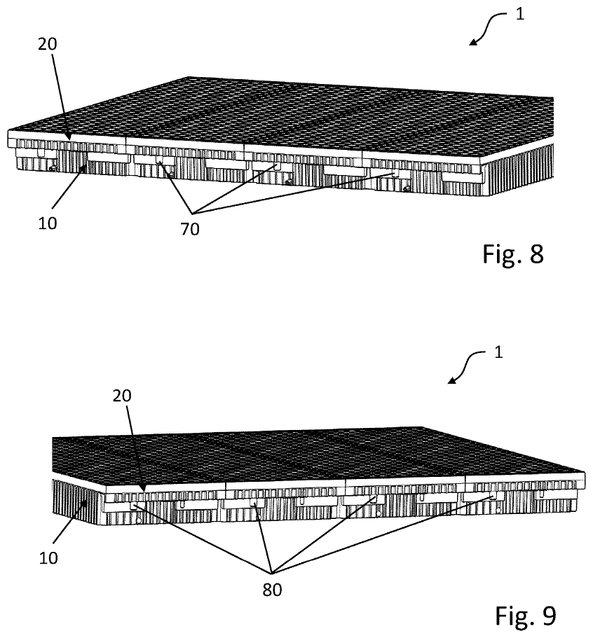

FIG. 8 is a perspectival view of a battery housing according to an eighth embodiment;

FIG. 9 is a further perspectival view of the battery housing according to the eighth embodiment; and

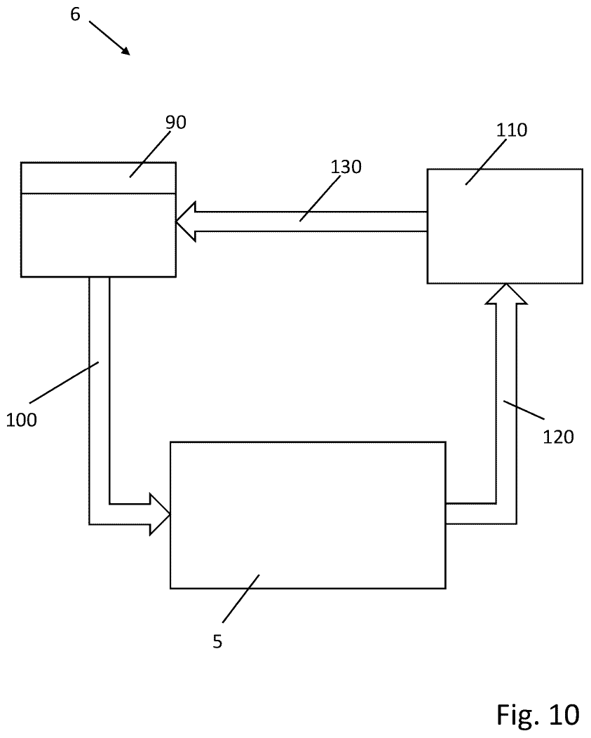

FIG. 10 is a schematic view of a battery system according to a ninth embodiment.

In the following description, the same reference signs denote the same components or features; in the interest of avoiding repetition, a description of a component made with reference to one drawing also applies to the other drawings. Furthermore, individual features that have been described in connection with one embodiment can also be used separately in other embodiments.

FIG. 1 is an exploded view of a battery housing 1 according to a first embodiment. The battery housing 1 has a first battery housing component 10, a second battery housing component 20, and a battery component holder 30, wherein the battery component holder 30 has a plurality of receiving cavities 31. The receiving cavities 31 each have an inner wall 311 which extends from a first opening 312 (not shown in FIG. 1) of the respective receiving cavity 31 to a second opening 313.

In the assembled state of the battery housing 1, the at least one battery component holder 30 is sandwiched between the first battery housing component 10 and the second battery housing component 20 and is connected to each of them such that the respective first openings 312 (not shown in FIG. 1) each face the first battery housing component 10, and the respective second openings 313 each face the second battery housing component 20. The battery component holder 30 is thus received in a receiving volume 2 of the battery housing 1 that is formed by the first battery housing component 10 and the second battery housing component 20. When the battery housing 1 is installed, e.g., in a motor vehicle, starting from a surface, e.g., a road, first the first battery housing component 10, then the battery component holder 30, and finally the second battery housing component 20 are arranged along a vertical direction.

The first battery housing component 10 has a circumferential inner wall contour 12 that corresponds to an outer wall contour 32 of the at least one battery component holder 30. In the assembled state of the battery housing 1, the at least one battery component holder 30 is connected to the first battery housing component 10 such that the outer wall contour 32 of the at least one battery component holder 30 conforms to the inner wall contour 12 of the first battery housing component 10. In other words, the outer wall contour 32 of the battery component holder 30 forms a positive connection with the inner wall contour 12 of the first battery housing component 10.

FIG. 2 is a sectional view of a battery component holder 30 of a battery housing 1 in the region of a receiving cavity 31 according to a second embodiment. The inner wall 311 of the receiving cavity 31 has at least one groove 40 extending from the first opening 312 to the second opening 313, so that, when battery components 3 are inserted into the receiving cavity 31, a respective cooling fluid channel 50 is formed which extends from the first opening 312 of the receiving cavity 31 to the second opening 313 of the receiving cavity 31 and is delimited by the groove 40 and the battery component 3 (not shown in FIG. 2).

The receiving cavities 31 are designed as through-openings in the battery component holder 30. The receiving cavities 31 have a circular, free cross-section. In other words, the receiving cavities 31 are hollow-cylindrical.

The at least one groove 40 along its longitudinal extension 42 has a varying groove depth 41, wherein the at least one groove 40 in the region of the first opening 312 of the receiving cavity 31 has a first groove depth 411 that is smaller than a second groove depth 412 in the region of the second opening 313 of the receiving cavity 31. The groove depth 41 transitions continuously from a first groove depth 411 in the region of the first opening 312 to a second groove depth 412 in the region of the second opening 313.

The groove depth 41 of the at least one groove 40 is the extension of the groove 40 in the radial direction, starting from a center of the first opening 312 and/or from a center of the second opening 313 of the receiving cavity 31.

The at least one groove 40 has a constant groove width 43 over the longitudinal extension 42 of the groove 40. The groove width 43 extends orthogonally to the longitudinal extension 42 of the groove 40 and orthogonally to the groove depth 41 of the groove 40.

The battery component holder 30 has a plurality of projections 33, each of which protrudes from an end face 34 of the battery component holder 30. The projections 33 are cylindrical. The projections 33 are designed to create a positive and/or non-positive connection between the battery component holder 30 and the first battery housing component 10 and/or the second battery housing component 20.

FIG. 3 is a perspectival view of a battery component holder 30 of a battery housing 1 in the region of a receiving cavity 31 according to a third embodiment. Along the longitudinal extension 42 of the groove 40, the groove depth 41 varies stepwise from a first groove depth 411 in the region of the first opening 312 of the receiving cavity 31 to a second groove depth 412 in the region of the second opening 313 of the receiving cavity 31.

The inner walls 311 of the respective receiving cavities 31 each have a crush rib 60 extending from the first opening 312 in the direction of the second opening 313, so that, when a battery component 3 is inserted into the receiving cavity 31, the crush rib 60 is deformed, and the battery component 3 is held without play in the receiving cavity 31. The crush rib 60 is monolithically connected to the inner wall 311 of the receiving cavity 31.

FIG. 4 shows a battery component holder 30 of a battery housing 1 according to a fourth embodiment in a plan view of the respective second openings 313 of the receiving cavities 31. The battery component holder has a plurality of projections 33 which protrude from an end face 34 of the battery component holder 30 and are monolithically connected to the battery component holder 30. The projections 33 are designed as a cylindrical peg 35, wherein the peg 35 tapers conically in the upper region of the peg 35. The peg 35 is designed to be received in a receiving groove (not shown in FIG. 4) corresponding to the peg 35 and to form a clamping connection between the peg 35 and the receiving groove. The receiving groove (not shown in FIG. 4) is arranged in the second battery housing component 20 and is monolithically connected to the second battery housing component 20.

The inner walls 311 of the respective receiving cavities 31 of the battery component holder 30 have grooves 40 arranged in groups relative to one another. Some inner walls 311 of some receiving cavities 31 of the battery component holder 30 have grooves 40 arranged in groups of two 44 relative to one another. Some inner walls 311 of some other receiving cavities 31 of the battery component holder 30 have grooves 40 arranged in groups of three 45 relative to one another.

The inner walls 311 of the respective receiving cavities 31 each have at least one stabilizer rib 61 extending from the second opening 313 in the direction of the first opening 312. It is possible that the stabilizer rib 61 has a decreasing height extension along its longitudinal extension, starting at the second opening 313 in the direction of the first opening 312.

FIG. 5 shows a battery component holder 30 of a battery housing 1 in the region of a receiving cavity 31 according to a fifth embodiment in a plan view of the first opening 312 of the receiving cavity 31. The inner wall 311 of the receiving cavity 31 has four crush ribs 60 which extend from the first opening 312 in the direction of the second opening 313 and are each monolithically connected to the inner wall 311. The crush ribs 60 are equidistant from one another.

The respective grooves 40 have a first groove depth 411 in the region of the first opening 312 of the receiving cavity 31. The grooves 40 have a constant groove width 43 along the longitudinal extension 42 of the groove 40.

FIG. 6 is a perspectival view of a battery component holder 30, inserted into a first battery housing component 10, of a battery housing 1 according to a sixth embodiment. The first battery housing component 10 has a structured inner support surface 11 with a plurality of protrusions 111, wherein the plurality of protrusions 111 are arranged opposite the plurality of first openings 312 of the respective receiving cavities 31 of the at least one battery component holder 30, so that, when battery components 3 are inserted into the receiving cavities 31, the battery components 3 rest upon the respective protrusions 111. The protrusions 111 are cylindrical and have a smaller diameter than the receiving cavities 31 of the battery component holder 30.

The structured inner support surface 11 of the first battery component 10 has a plurality of connecting protrusions 112 extending from the inner support surface 11 of the first battery housing component 10 into the receiving volume 2 of the battery housing 1. The connecting protrusions 112 are cylindrical and are each arranged adjacent to three protrusions 111.

FIG. 7 is a sectional view of a battery 5 in the region of receiving cavities 31 according to a seventh embodiment. A plurality of battery components 3 designed as battery cells 4 are inserted into the receiving cavities 31 of the battery component holder 30. The battery cells 4 rest upon the protrusions 111 of the inner support surface 11 of the first battery housing component 10. The battery component holder 30 is integrally connected to the connecting protrusions 112 of the inner support surface 11 of the first battery housing component 10.

The battery cells 4 inserted into the receiving cavities 31 of the battery component holder 30 form cooling fluid channels 50 with the respective grooves 40 of the respective receiving cavities 31 into which the battery cells 4 are inserted. The cooling fluid channels 50 extend from the respective first openings 312 of the receiving cavities 31 to the respective second openings 313 of the respective receiving cavities 31 and are each delimited by the respective grooves 40 and the battery cells 4 inserted into the receiving cavities 31.

The cooling fluid channels 50 each have an inlet opening 51 in the region of the first opening 312 of the receiving cavity 31 and an outlet opening 52 in the region of the second opening 313 of the receiving cavity 31.

During operation of a battery 5 according to the seventh embodiment, liquid cooling fluid (not shown in FIG. 7) is present between the protrusions 111 of the inner support surface 11 of the first battery component 10 in a reservoir in a state near the boiling point of the cooling fluid. Due to the pressure present in the cooling fluid, the cooling fluid rises through the inlet openings 51 of the cooling fluid channel 50 into the cooling fluid channel 50 against the force of gravity and, in doing so, absorbs heat from the battery cells 4. Due to the absorbed heat, the cooling fluid begins to boil and evaporate. The evaporating cooling fluid continues to rise along the cooling fluid channel 50, absorbing heat from the battery cell 4, and exits from the outlet opening 52 of the cooling fluid channel 50 with a vapor content in the range of 50%.

FIG. 8 is a perspectival view of a battery housing 1 according to an eighth embodiment. The battery housing 1 has four cooling fluid inlets 70 for supplying a cooling fluid to a receiving volume 2 of the battery housing 1, wherein the four cooling fluid inlets 70 are in fluidic connection with the respective first openings 312 of the at least one battery component holder 30. The cooling fluid inlets 70 are formed in the first battery housing component 10. The cooling fluid inlets 70 are arranged in the lower region of the first battery housing component 10.

FIG. 9 is a further perspectival view of the battery housing 1 according to the eighth embodiment. The battery housing 1 has three cooling fluid outlets 80 for discharging the cooling fluid from the receiving volume 2 of the battery housing 1, wherein the cooling fluid outlets 80 are in fluidic connection with the respective second openings 313 of the at least one battery component holder 30. The cooling fluid outlets 80 are formed in the first battery housing component 10. The cooling fluid outlets 80 are arranged in the upper region of the first battery housing component 10.

FIG. 10 is a schematic view of a battery system 6 according to a ninth embodiment. The battery system 6 has a battery 5 with a battery housing 1 according to the eighth embodiment and with a plurality of battery components 3 designed as battery cells 4 and inserted into the receiving cavities 31 of the at least one battery component holder 30. The battery system 6 further has a cooling fluid storage container 90, wherein the cooling fluid storage container 90 is fluidically connected to the at least one cooling fluid inlet 70 of the battery housing 1 via a fluid inlet line 100 for supplying cooling fluid to the receiving volume 2 of the battery housing 1. Finally, the battery system 6 has a heat exchanger device 110, wherein the heat exchanger device 110 is fluidically connected to the at least one cooling fluid outlet 80 by means of a fluid outlet line 120 for discharging the cooling fluid from the receiving volume 2 of the battery housing, wherein the heat exchanger device 120 is fluidically connected by means of a storage fluid inlet line 130 to the cooling fluid storage container 90 for supplying liquid cooling fluid.

### LIST OF REFERENCE SIGNS

1 Battery housing
2 Receiving volume (of the battery housing)
3 Battery components
4 Battery cells
5 Battery
6 Battery system
10 First battery housing component
11 Inner support surface (of the first battery housing component)
111 Protrusion (of the inner support surface)
112 Connecting protrusions (of the inner support surface)
12 Inner wall contour (of the first battery housing component)
20 Second battery housing component
30 Battery component holder
31 Receiving cavity
311 Inner wall
312 First opening
313 Second opening
32 Outer wall contour (of the battery component holder)
33 Projection (of the battery component holder)
34 End face (of the battery component holder)
35 Peg
40 Groove
41 Groove depth
411 First groove depth
412 Second groove depth
42 Longitudinal extension (of the groove)
43 Groove width
44 Group of two (grooves)
45 Group of three (grooves)
50 Cooling fluid channel
51 Inlet opening (of the cooling fluid channel)
52 Outlet opening (of the cooling fluid channel)
60 Crush rib
61 Stabilizer rib
70 Cooling fluid inlet
80 Cooling fluid outlet
90 Cooling fluid storage container
100 Fluid inlet line
110 Heat exchanger device
120 Fluid outlet line
130 Storage fluid inlet line

1. A battery housing for receiving a plurality of battery components, having
a first battery housing component;
a second battery housing component; and
at least one battery component holder having a plurality of receiving cavities for receiving the battery components,
wherein the receiving cavities each have an inner wall which extends from a first opening of the respective receiving cavity to a second opening of the respective receiving cavity, and
wherein the at least one battery component holder is sandwiched between the first battery housing component and the second battery housing component and is connected to each of them such that the respective first openings each face the first battery housing component, and the respective second openings each face the second battery housing component,
wherein the battery housing is characterized by the following feature:
the inner walls of the respective receiving cavities each have at least one groove extending from the first opening to the second opening, so that, when a battery component is inserted into the receiving cavity, a respective cooling fluid channel is formed which extends from the first opening of the receiving cavity to the second opening of the receiving cavity and is delimited by the groove and the battery component.

2. The battery housing according to claim 1, characterized in that the at least one groove along its longitudinal extension has a varying groove depth.

3. The battery housing according to claim 2, characterized in that the groove depth of the at least one groove varies stepwise along its longitudinal extension.

4. The battery housing according to claim 2, characterized in that the at least one groove in the region of the first opening of the receiving cavity (has a first groove depth that is smaller than a second groove depth in the region of the second opening of the receiving cavity.

5. The battery housing according to claim 4, characterized in that the first groove depth is between 0.1 mm and 1 mm, and in that the second groove depth is between 0.5 mm and 2 mm.

6. The battery housing according to claim 4, characterized in that the at least one groove has the first groove depth over a longitudinal extension of 1 mm to 8 mm,

7. The battery housing according to claim 1, characterized in that the inner walls of the respective receiving cavities each have at least one crush rib extending from the first opening in the direction of the second opening, so that, when a battery component is inserted into the receiving cavity, the crush rib is deformed, and the battery component is held without play in the receiving cavity.

8. The battery housing according to claim 7, characterized in that the at least one crush rib extends from the first opening of the receiving cavity (over a length of 5 mm to 15 mm, in the direction of the second opening of the receiving cavity.

9. The battery housing according to claim 7, characterized in that the at least one crush rib has a height extension of 0.1 mm to 0.5 mm;

10. The battery housing according to claim 1, characterized by the following features:
the first battery housing component has a structured inner support surface with a plurality of protrusions; and
the plurality of protrusions are arranged opposite the plurality of first openings of the respective receiving cavities of the at least one battery component holder so that, when battery components are inserted into the receiving cavities, the battery components rest upon the respective protrusions.

11. The battery housing according to claim 1, characterized by the following features:
the first battery housing component has a circumferential inner wall contour that corresponds to an outer wall contour of the at least one battery component holder; and
the at least one battery component holder is connected to the first battery housing component such that the outer wall contour of the at least one battery component holder conforms to the inner wall contour of the first battery housing component.

12. The battery housing according to claim 1, characterized by the following features:
the battery housing has at least one cooling fluid inlet for supplying a cooling fluid to a receiving volume of the battery housing;
the battery housing has at least one cooling fluid outlet for discharging the cooling fluid from the receiving volume of the battery housing;
the at least one cooling fluid inlet is in fluidic connection with the respective first openings of the at least one battery component holder; and
the at least one cooling fluid outlet is in fluidic connection with the respective second openings of the at least one battery component holder.

13. The battery housing according to claim 12, characterized in that the at least one cooling fluid inlet and/or the at least one cooling fluid outlet is/are formed in the first battery housing component.

14. A battery having athe battery housing according to claim 1 and having athe plurality of battery components designed as battery cells and/or as battery modules and inserted into the receiving cavities of the at least one battery component holder.

15. A battery system, having:
athe battery with athe battery housing according to claim 12 and with athe plurality of battery components designed as battery cells and/or as battery modules and inserted into the receiving cavities of the at least one battery component holder;
a cooling fluid storage container which is fluidically connected to the at least one cooling fluid inlet via a fluid inlet line for supplying cooling fluid to the receiving volume of the battery housing; and
a heat exchanger device which is fluidically connected to the at least one cooling fluid outlet by means of a fluid outlet line for discharging the cooling fluid from the receiving volume of the battery housing, wherein the heat exchanger device is fluidically connected to the cooling fluid storage container for supplying liquid cooling fluid.
